(19) United States
(12) Patent Application Publication
(10) Pub. No.: US 2026/0296610 A1
(43) Pub. Date: Oct. 1, 2026

(54) DIVE MASK

(71) Applicant: DIVEPRO S.A., Attikis (GR)

(72) Inventors: Nikolaos VALANTASSIS-KANELLOS, Drosia (GR); Theodoros ATHANASSOPOULOS, Spata (GR); Antonis DEPASTAS, Pikermi (GR)

(21) Appl. No.: 19/477,331

(22) PCT Filed: Mar. 26, 2024
(86) PCT No.: PCT/EP2024/058084

§ 371 Date: Oct. 21, 2025

(30) Foreign Application Priority Data
Apr. 27, 2023 (GR) 20230100351

(51) Int. Cl. B63C 11/12; B63C 11/02; B63C 11/26; H04R 1/10; H04W 4/029; H04W 4/80

(52) U.S. Cl. CPC B63C 11/12; B63C 11/26; H04R 1/10; H04W 4/029; H04W 4/80; B63C 2011/021; B63C 2011/121; H04R 2460/13

(57) ABSTRACT

Dive mask characterized in that it includes a main processor, data storage means, connected to the main processor sensors for collecting data in real time, connected to the main processor means of information provision to the diver concerning this data in real time and a power source, configured to provide the mask components with the necessary for the operation power by means of a power system.

Water sports were always one of the most popular training and activity fields with plenty of different options and participation motives which may be related to recreation, research, amateur and professional sports. In recent years, technological development has radically changed the way we engage in water activities, giving them new features, making them safer, and considerably broadening the potential of the professionals and the field.

In particular, the methods and means employed in marine life observation and exploration have been considerably evolved, altering the balance between human potential and nature. Freediving, SCUBA diving and breath-hold diving have been considerably developed, occupying an important position in the water activities market, while belonging to the mature recreation activities market and the emerging extreme sports market.

Diving equipment plays a prominent role as it considerably improves safety levels, protects the trainee from external conditions and unforeseen events and reduces the likelihood of human error as well as the consequences of its occurrence. In addition, the technological development of the equipment may turn diving into a specialized market aimed at experienced divers, technical divers or beginners seeking the support and capabilities of innovative equipment.

However, dive market lacks an equipment having the ability to provide divers with data concerning the parameters they are interested in in real time, so that they can effectively analyze the situation, take the right decisions and appropriate safety measures.

The present invention intends to present a dive mask that has the ability to collect and provide data to the users/divers concerning the parameters in which they are interested in real time. This is achieved by a mask according to claim 1. Further implementations and applications of the invention are the object of the dependent claims.

According to the invention and referring to claim 1 a dive mask is proposed, which includes a main processor, data storage means, sensors for data collection in real time connected to the main processor, connected to the main processor means of information provision to the diver concerning this data in real time and a power source (battery), configured to provide the mask components with the necessary for the operation power by means of a power control system.

According to an advantageous implementation of the invention the mask further includes a communication system, connected to the main processor, configured in such a way that it allows two-way communication of the mask with mobile electronic devices, with a cloud server or/and with positioning satellite constellations.

The communication system may contain at least one of the following:
SONAR transceiver allowing low bitrate underwater communications with other compatible devices, such as pressure gauges and other buddy diver's masks,
GNSS (Global Navigation Satellite System) and 2G/4G/5G communications unit allowing the calculation of the mask position on earth based on satellite constellations such as e.g. Gallileo, Beidu, GPS, Glonass. At the same time, it allows cellular communication of the mask with the computing cloud for transmission of diving data, profile configurations, firmware/software updates,
Bluetooth/NFC unit for close distance connections to mobile devices
Interface for system commands which for example may be tactile interface capacitive, magnetic, or resistive, or even a simple key.

The main processor is responsible for running the operating system, the mask software as well as controlling all components of the mask and their interfaces. All data is collected by the main processor, which is responsible for storing it in the local memory, that is, the data storage means. The main processor orchestrates and executes the operation state machine wherein among other things it performs the following functions:
Collects the sensor data.
Carries out calculations based on predetermined models to transform the sensor data into information for the user.
Forwards the information for the user to the information provision means.
Acts as dive computer for freedivers.
Calculates the dive time, the surface time, the surface orientation, the burned calories and provides timestamp and timer and forwards this information for the user to the information provision means.
Monitors the performance of the mask components and users and sends notifications by means of the information provision means when values beyond limits are detected.
In case the mask includes communication system the main processor checks the availability of position recording and communications for forwarding or receiving data and is responsible for forwarding all of or selected stored data to the computing cloud directly by means of cellular communication interface or Bluetooth interface of mobile electronic device of the user as soon as possible.

According to the invention, the sensors of the sensor system for the collection of data in real time contain at least two of the following sensors:
Pressure sensor, providing information concerning the diver's depth. For example, the pressure sensor has the ability to zero the depth on the water surface or out of water and starts measuring in relation to the pressure on surface or out of it to calculate the respective diver's depth.
IMU (inertial measurement unit) sensor, providing information concerning 3-axis acceleration/deceleration, heading, direction and pitch, roll, and yaw. This information allows analysis and monitoring of the dive, while at the same time allows indications to the diver concerning the diving heading in real time so that confusion of the divers is prevented and the movement line underwater is recorded/analyzed.

Furthermore, having the initial position on the surface allows, by using the inertial sensors, to calculate the position in relation to the initial position spot.
SpO₂ (oxygen saturation) sensor monitoring the oxygen saturation in divers' blood, the arterial blood pressure, the heart rate and the burned calories.
Temperature sensor for monitoring the diver's temperature.
Temperature sensor for monitoring the water temperature, which can be integrated into a water temperature and depth/pressure sensor.

The means of information provision to the user include at least one of the following:
Bone conduction headphones wherein the information is provided through the maxillary bone without the need of in-ear headphones, which are positioned in the mask on a spot tangentially to the maxilla, in such a way that bone conduction is ensured.
Augmented reality display wherein the information is shown in monochrome or color (RGB) form on the mask glass, by means of micro led displays and optical waveguides on one or both eyepieces.
Vibration motor further used in combination with audio signal in case bone conduction headphones are envisaged or/and optical signal in case augmented reality display is envisaged to notify the user in case of values beyond data limits or detected dangerous/critical situations.

Information that can be provided depending on the sensor consists e.g. in the following:
Water Temperature.
Water pressure, depth
Body temperature
Oxygen saturation
Heart rate
Blood pressure, which is calculated by the main processor with data from the SPO2 sensor, preferably according to the photoplethysmography pulsation analysis method.
Burned calories, calculated on the basis of heart rate, body weight, age and gender.
Heading and direction
GNSS location
Cellular telecommunications signal power and state.
Battery state
Local information of the diving environment (weather, currents, dangers) by means of the communication unit and the positioning by means of GNSS
Dive computer notifications.
Digital compass

According to a preferred implementation of the invention the sensors are integrated into the mask. Alternatively the sensors may be connected to the mask by means of appropriate interfaces.

In addition and according to a preferred implementation of the invention the mask glass may further integrate anti-glare mechanism so that there will never be glare on the glass due to the diver's skin moisture.

The anti-glare mechanism according to the invention controls and adjusts the mask glass temperature so that the circumstances do not allow the occurrence of dew point. The anti-glare mechanism according to the invention can be integrated into any dive masks or even sea masks (snorkeling), as well as masks for winter sports without the need of the sensors and systems described in relation to the dive mask according to the invention.

The anti-glare mechanism prevents the glare of the eyepiece, especially when there is large difference of temperature between the water or, in the case of winter sports mask, the air contacting the polycarbonate or tempered glass.

For example, during the diving procedure glare tends to occur on the eyepiece glass due to the moisture coming from the skin of the diver, from the remaining water during the mask application as well as from the exhalation air percentage during pressure equalization. This occurs because humidity which is very close to body temperature (~36° C.) condenses on the internal surface of the eyepiece glass due to the lower temperature it has.

In the present the described anti-glare mechanism reduces or/and prevents condensation of the moisture by keeping the internal surface in such a temperature that the occurrence of dew point is not allowed. Due to the fact e.g. that in the case of a dive mask the glass surface contacting the water is such that it allows heat dissipation at a rate which is higher than the heating rate of the glass by an internal resistance with sensible energy consumption, the insulation of the glass by means of the layer method is envisaged. The mask glass consists of 3 layers. From the outside to the inside there is the polycarbonate or tempered glass followed by the waveguide glass, followed by waveguide protection membrane with integrated resistor and temperature sensor. The waveguide glass and membrane assembly is insulated from the polycarbonate or tempered glass by means of transparent gel with low thermal conductivity coefficient.

In a main processor a PID controller is implemented which controls the temperature in the membrane by means of the temperature sensor and adjusts the current coming from a power source, which flows through the resistor so that the temperature is kept at a level in which the occurrence of dew point is prevented by optionally further using a temperature sensor on the diver's body and supposing that the contained moisture percentage on the internal side of the mask is >98%.

The signal of the temperature sensor and the resistance current are led through a flexible bus (flex technology) connected to the main processor. By means of the main processor is also envisaged diagnosis of the state of resistance for open circuit or short circuit.

For conventional dive masks or sea masks (snorkeling) or winter sports masks are proposed two versions of the anti-glare mechanism, which can be integrated into any dive, sea or winter sports mask.

The first version further comprises electronic parts and the operating principle is identical to the dive mask's operating principle according to the invention and the above description. The difference lies in the fact that the conventional mask does not have a waveguide, which is replaced by a polycarbonate glass on which is installed membrane with resistor and temperature sensor. The polycarbonate glass and membrane assembly is insulated from the polycarbonate or tempered glass which is the external glass of the mask, by means of transparent gel with low thermal conductivity coefficient.

The second version is a passive form of the anti-glare mechanism which doesn't have any electronics and comprises the external tempered glass of the mask, internal polycarbonate glass as well as an intermediate (between the 2 glasses) layer of transparent gel with low thermal conductivity coefficient. In the passive version this results in considerable reduction of the temperature decrease of the internal glass due to the heat dissipation by the water while in the active versions with electronic parts is achieved maintenance of the temperature at levels above dew point.

The mask according to the invention advantageously fills the prior-art existing gap concerning the information of the diver and radically changes the safety levels and the way dives are executed by means of the provided features.

Furthermore, the mask is combined with data collection and processing platform concerning each dive for individual use by each user or trainer to reduce the danger, increase the safety, optimize the practice/training of the divers and assist in effective decision-making. The above mentioned possibilities offered by the mask according to the invention improve the diving techniques as they move from generalized to tailor-made models based on the physiology of each diver (gender, age, body type, oxygen saturation) as well as the environmental conditions (depth, temperature, currents, visibility etc.).

The material of the mask is preferably mainly silicone rubber formed by injection molding. The sensors, where possible, and cables are permanently integrated into the mask frame during the molding (injection molding or/and over molding), while sensors not being permanently integrated into the mask frame, such as e.g. diving cylinder pressure sensor can be connected to the mask by means of appropriate interfaces.

The present invention can be fully understood by the following detailed description in connection with the attached drawings in which:

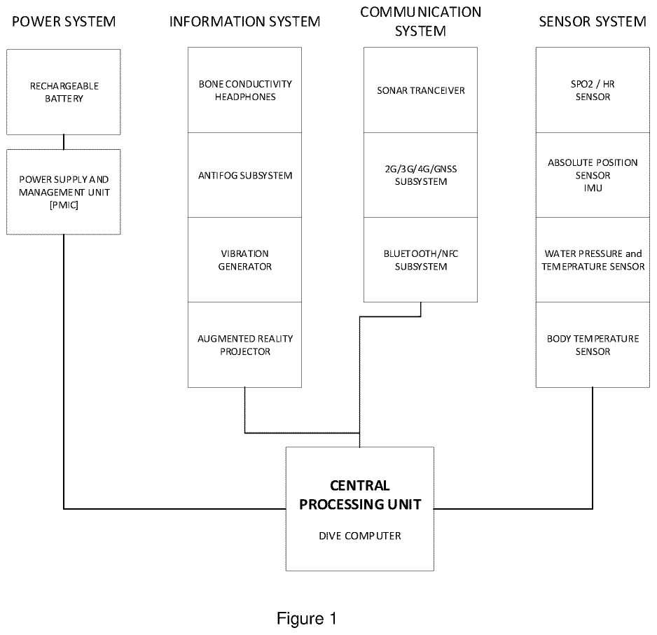

FIG. 1 shows a block diagram of the mask components according to one form of the invention,

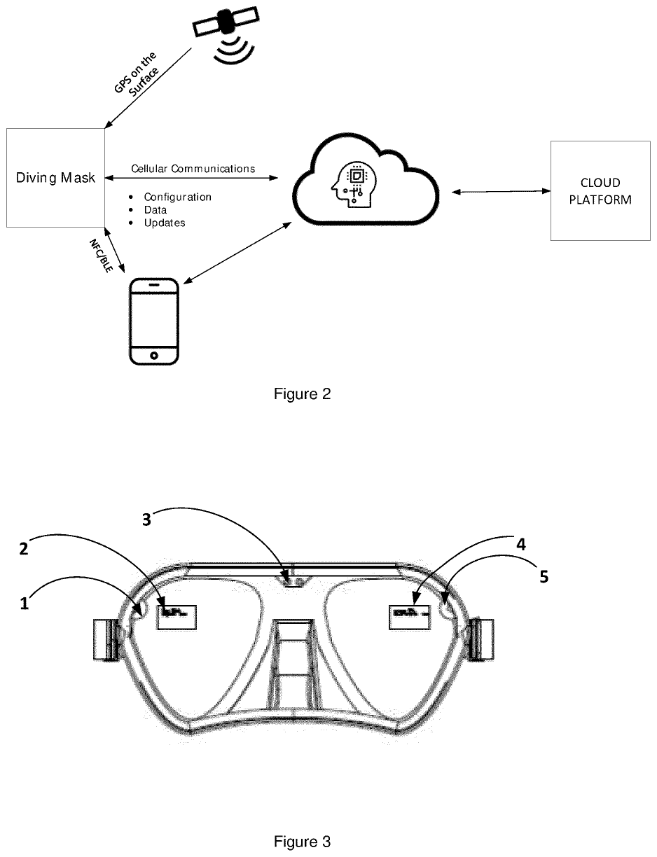

FIG. 2 schematically shows the communication potential of the mask by means of the communication system according to one form of the invention,

FIG. 3 shows a schematic front view of the mask according to one form of the invention,

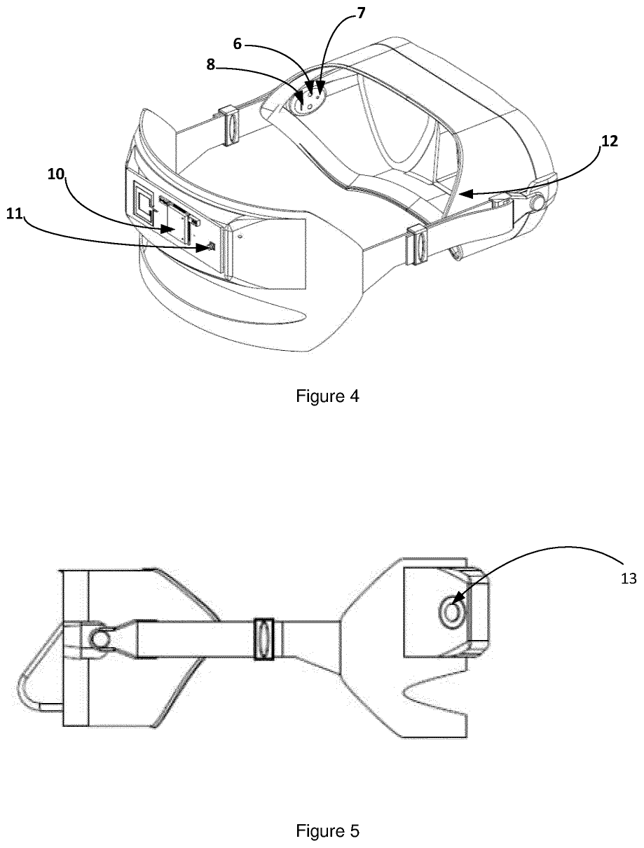

FIG. 4 shows a schematic perspective view of the mask according to one form of the invention,

FIG. 5 shows a schematic side view of the mask according to one form of the invention,

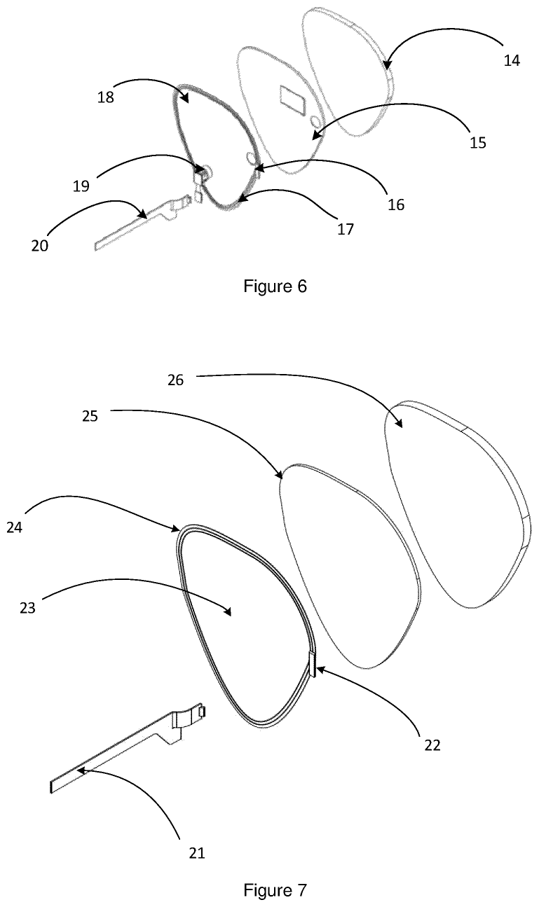

FIG. 6 schematically shows a dive mask glass containing anti-glare mechanism according to one form of the invention,

FIG. 7 schematically shows a glass for conventional dive masks or sea masks (snorkeling) or winter sports masks containing one version of anti-glare mechanism according to another form of the invention and

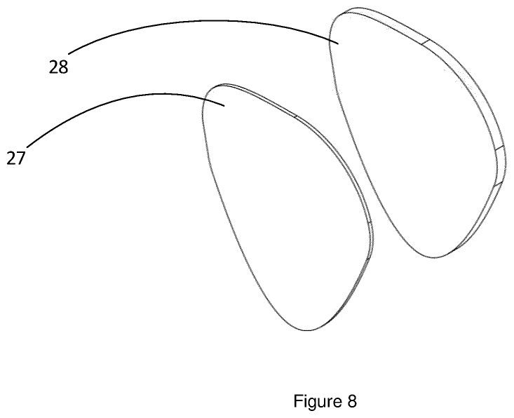

FIG. 8 schematically shows a glass for conventional dive masks or sea masks (snorkeling) or winter sports masks containing one version of anti-glare mechanism according to another form of the invention.

According to the invention and referring to FIG. 1 the mask includes a main processor, preferably multicore, which is responsible for running the operating system, the mask software as well as controlling all components and their interfaces. All data is collected by the main processor, which is responsible for storing it in the local memory, that is, in the data storage means, as well as forwarding all of or selected stored data to the computing cloud or to electronic device by means of the communication system as soon as possible by means of cellular communication interface or Bluetooth interface of the mask by means of a mobile device of the user. The main processor orchestrates and executes the operation state machine and among other things, as has already been mentioned, collects the sensor data, carries out calculations based on predetermined models to transform the various data into useful information for the user, forwards the information for the user to the information provision means and acts as dive computer for freedivers.

The mask includes a power system, which is responsible for handling the power source of the system (battery) as well as managing the power paths for each component, in order to allow the main processor to fully control the power functions of the mask and achieve effective power management extending the active diving time of the mask.

The power system includes as power source preferably a high-capacity and fast-charging rechargeable lithium battery, for example LiFePO4. The battery is connected to a supply, while the power system includes a PMIC (power management integrated circuit) which is responsible for the following functions:
Connecting and disconnecting the battery to/from the system
Monitoring the battery state of health (remaining useful life, internal resistance)
Monitoring the charge/discharge state
Monitoring the capacity state
Running the charge algorithm when it is connected to charger.
Protecting the battery from overheating, draw, surge, short circuit, overcharge and overdischarge.
Controlling the multi-channel power outputs for the various power sectors with the ability to partially deactivate/activate them.

The mask includes information system allowing the forms of information provision to the user, which includes information provision means, such as in the example of FIG. 1 bone conduction headphones wherein the information is audibly provided through the maxillary bone without the need of headphones, augmented reality display wherein the information is shown in monochrome or color RGB form on the mask glass using micro led displays and optical waveguides on the one or both mask eyepieces, while the mask glass integrates anti-glare mechanism, vibration motor/generator further used in combination with audio or/and optical signal to notify the diver in case of values beyond data limits or detected dangerous/critical situations.

Furthermore, the mask in the example of FIG. 1 includes, as has already been mentioned, communication system allowing two-way communication of the mask with mobile devices or the computing cloud or even positioning satellite constellations. This system in the presented example includes SONAR transceiver, GNSS tracking unit, of 2G/4G/5G communications, Bluetooth/NFC unit for close distance connections to mobile devices and interface for system commands such as start and end of operation and force start of diagnostics. The interface for system commands may be for example tactile interface, capacitive, magnetic, or resistive, or even a simple key. The Bluetooth/NFC unit is also used for close distance connections to mobile devices, e.g. for the initial configuration of the mask using a mobile device application and transferring data to the mask). The end user may choose to perform data exchange with the mask by means of the application using his/her own mobile network by means of a corresponding mobile device.

The functions of the communication system are presented in FIG. 2. The mask and other devices (cell phones, cloud servers, positioning constellations) are interconnected in various ways so that the mask acts as member of an ecosystem providing the end user with full services.

According to the invention in the example of FIG. 2 the mask automatically connects to positioning satellites as soon as it is authorized to do so and determines its position on earth in order to “know” its position. This is used in two ways. First, the mask may have different options and different configuration based on location and dive type. In the second place, the location data can be used to complete the diving data analysis and data presentation.

When the mask is out of water, it can either directly communicate with a computing cloud server in the user account by means of cellular communication, or by means of Bluetooth connection with a nearby mobile device connected securely to the mask. For low data volumes or fast configurations, the NFC interface is also used with mobile devices.

As soon as the data is uploaded to the computing cloud server, it is stored in a time series database which is accessed by the data statistical analysis processors and the Artificial Intelligence (AI) & Machine Learning (ML) algorithms. The unprocessed data as well as the information created by the process algorithms are presented on control tables hosted by the computing cloud servers. At the cloud platform the accounts are unique for each end user or multiple with structures for organizations, sub-organizations, and end users.

Based on the communication system a series of services/features can be provided such as mask positioning using real time Ping, sending of notifications to the mask (when this is technically feasible, e.g. when the mask is out of water as well as training services in mask use.

The mask includes sensor system which in the example of FIG. 1 includes pressure sensors, IMU sensor, SpO₂ sensor and temperature sensors for monitoring the diver's temperature as well as the water temperature.

The temperature sensors continually monitor the water temperature and the diver's body temperature. According to the invention the algorithm of the SpO₂ sensor has the ability to start with an initial calibration on the surface as soon as the mask is worn to eliminate any possible errors due to the placement of the sensor on the body (forehead or temple) and then begins to record the SpO₂ levels, the arterial blood pressure by means of algorithm and the main processor and the heart rate at every predetermined number of seconds.

The IMU data as with the accurate timestamps monitor the divers' movements underwater in order to allow full reconstruction of the dive as soon as it is provided to the cloud platform.

All the above can also be turned into dive computer functionality of the mask. This is a function allowing the dive scheduling in a way similar to the one offered by the current dive computers, however, the algorithm of the dive computer now works not only at predetermined dive steps with timing but also based on real time measurements, allowing the mask to detect whether the dive schedule is followed or there is a schedule deviation providing information and suggestions on the display as well as alerts in case it detects critical events coming either from the dive schedule or from the physiology and environment measurements.

In the example of FIGS. 3 and 4 a mask is presented including augmented reality display wherein the information is shown in monochrome or color RGB form on the mask glass using micro led displays 1, 5 and optical waveguides 2, 4 on both mask eyepieces. Furthermore, the mask includes oxygen saturation SpO₂ optical sensors 7, 3, 12, body temperature sensor 8, 12 and water temperature and depth/pressure sensor 11.

In the schematic perspective view of the mask of FIG. 4 is also shown an electronic module box, of battery, vibration generator and IMU. A Sonar transceiver 13 is shown in FIG. 5. Moreover, in FIG. 4 are shown Bluetooth unit 10, NFC unit 10, GNSS 2G/4G/5G unit 10, bone conduction headphones 6, and interface for system commands. In other versions two or more communication system parts may be integrated into a chip.

In FIG. 6 the anti-glare mechanism of the mask is described. The glass in this example consists of 3 layers. From the outside to the inside there is the polycarbonate or tempered glass 14 followed by the waveguide glass 15, followed by waveguide protection membrane 18 with integrated resistor 17 and temperature sensor 16. The waveguide glass and membrane assembly is insulated from the polycarbonate or tempered glass by means of transparent gel with low thermal conductivity coefficient. Furthermore, the assembly of the augmented reality projector 19 and a control, data and energy bus 20 is shown.

In the main processor a PID controller is implemented which controls the temperature in the membrane by means of the temperature sensor 16 and adjusts the current which flows through the resistor 17 so that temperature is kept at a level wherein the occurrence of dew point is prevented by further using the mask temperature sensor on the diver's body and supposing that the contained moisture percentage on the internal side of the mask is >98%. The signal of the temperature sensor, the digital data for the AR projector as well as the resistance current are led through a flexible bus (flex technology) which connects to the main processor system.

In FIG. 7 anti-glare mechanism for conventional dive masks or sea masks (snorkeling) or winter sports masks is described. As shown in FIG. 7 the mask includes from the outside to the inside external glass 26 and internal polycarbonate glass 25, on which membrane 23 with resistor 24 and temperature sensor 22 is installed. In a main processor a PID controller is implemented which controls the temperature in the membrane by means of the temperature sensor and adjusts the current that flows through the resistor 24 by means of a control, data and energy bus 21 in such a way that temperature is kept at a level wherein the occurrence of dew point is prevented.

In FIG. 8 a simpler anti-glare mechanism for conventional dive masks or sea masks (snorkeling) or winter sports masks is described. The mask includes from the outside to the inside the external glass 28, an internal polycarbonate glass 27 as well as an intermediate transparent gel layer with low thermal conductivity coefficient.

1. A dive mask which includes a main processor, data storage means, sensors for data collection in real time connected to the main processor, connected to the main processor means of information provision to the diver concerning this data in real time and a power source, configured to provide the mask components with the necessary for the operation power by means of a power system, wherein the mask glass integrating anti-glare mechanism, characterized in that the mask glass from the outside to the inside includes polycarbonate or tempered glass followed by waveguide glass, followed by waveguide protection membrane with integrated resistor and temperature sensor, wherein the waveguide glass and membrane assembly is insulated from the polycarbonate or tempered glass by means of transparent gel with low thermal conductivity coefficient, wherein in the main processor a PID controller is implemented which controls the temperature in the membrane by means of the temperature sensor and adjusts the current which flows through the resistor so that the temperature is kept at a level where the occurrence of dew point is prevented by further using the temperature sensor of the mask on the diver's body and supposing that the contained moisture percentage on the internal side of the mask is >98%.

2. The dive mask according to claim 1, further comprising a communication system, connected to the main processor, configured in such a way that it allows two-way communication of the mask with mobile electronic devices, with computing cloud servers or/and with positioning satellite constellations.

3. The dive mask according to claim 2, wherein the communication system further includes at least one of the following:
SONAR transceiver allowing low bitrate underwater communications with other compatible devices, such as pressure gauges and other buddy diver's masks
GNSS (Global Navigation Satellite System) 2G/4G/5G unit allowing the calculation of the mask position on earth based on satellite constellations such as e.g. Gallileo, Beidu, GPS, Glonass, which at the same time, allows cellular communication of the mask with the computing cloud for transmission of diving data, profile configurations, firmware/software updates,
Bluetooth/NFC unit for close distance connections to mobile devices,
Interface for system commands.

4. The dive mask according to claim 1, further comprising at least two of the following sensors:
Pressure sensor, providing information concerning the diver's depth,
IMU (inertial measurement unit) sensor, providing information concerning 3-axis acceleration/deceleration, heading, direction and pitch, roll and yaw,
SpO₂ sensor monitoring the oxygen saturation in the divers' blood, the arterial blood pressure, the heart rate and the burned calories,
Temperature sensor for monitoring the diver's temperature, and
Temperature sensor for monitoring the water temperature.

5. The dive mask according to claim 1, wherein the means of information provision to the user further include at least one of the following:
Bone conduction headphones wherein the information is audibly provided through the maxillary bone without the need of headphones, which are positioned in the mask on a spot tangentially to the maxilla, in such a way that bone conduction is ensured,
Augmented reality display wherein the information is presented in monochrome or color (RGB) form on the mask glass, by means of micro led displays and optical waveguides on one or both eyepieces, and
Vibration motor further used in combination with audio signal in case bone conduction headphones are envisaged or/and optical signal in case augmented reality display is envisaged to notify the diver in case of values beyond data limits or detected dangerous/critical situations.

6. The dive mask according to claim 1, wherein the main processor is responsible for running the operating system and mask software as well as controlling all components of the mask and their interfaces, wherein all data is collected by the main processor, which is responsible for storing it in the data storage means, wherein the main processor among other things performs the following functions:
Collects the sensor data,
Carries out calculations based on predetermined models to transform the sensor data into information for the user,
Forwards the information for the user to the information provision means
Acts as dive computer for freedivers,
Calculates the dive time, the surface time, the surface orientation, the burned calories and provides timestamp and timer and forwards this information for the user to the information provision means,
Monitors the performance of the mask components and users and sends notifications by means of the information provision means when values beyond limits are detected,
Checks the availability of position recording and communications for forwarding or receiving data and is responsible for forwarding all of or selected stored data to the computing cloud or to electronic device by means of the communication system as soon as possible by means of cellular communication interface or Bluetooth interface of the mask by means of a mobile device of the user.

7. The dive mask according to claim 4, wherein the sensors are integrated into the mask.

8. A dive, sea or winter sports mask, wherein the mask includes, from the outside to the inside, external glass being polycarbonate or tempered glass and internal polycarbonate glass, on which membrane with resistor and temperature sensor is installed, the polycarbonate glass and membrane assembly being insulated from the external glass of the mask, by means of transparent gel with low thermal conductivity coefficient, wherein in a main processor a PID controller is implemented which controls the temperature in the membrane by means of the temperature sensor and adjusts the current that flows through the resistor by means of a control, data and energy bus in such a way that temperature is kept at a level wherein the occurrence of dew point is prevented by further using a temperature sensor of the mask on the diver's body and supposing that the contained moisture percentage on the internal side of the mask is >98%.

9. An anti-glare mechanism for a dive, sea or winter sports mask, wherein the mask includes external glass being polycarbonate or tempered glass, the mechanism including internal polycarbonate glass, on which a membrane with resistor and temperature sensor is installed, the polycarbonate glass and membrane assembly being insulated from the external glass of the mask, by means of transparent gel with low thermal conductivity coefficient, the mechanism further comprising a main processor in which a PID controller is implemented, which controls the temperature in the membrane by means of the temperature sensor and adjusts the current that flows through the resistor by means of a control, data and energy bus in such a way that temperature is kept at a level wherein the occurrence of dew point is prevented by further using a temperature sensor of the mechanism on the mask on the diver's body and supposing that the contained moisture percentage on the internal side of the mask is >98%.

10. A dive, sea or winter sports mask, wherein the mask includes from the outside to the inside, external glass (28), an internal polycarbonate glass (27) as well as an intermediate transparent gel layer with low thermal conductivity coefficient.
